(19) United States
(12) Patent Application Publication
(10) Pub. No.: US 2026/0267146 A1
(43) Pub. Date: Sep. 10, 2026

(54) VISUAL SYSTEM

(71) Applicant: ZHEJIANG SUNNY OPTICS CO., LTD., Yuyao City (CN)

(72) Inventors: Huan LIU, Yuyao City (CN); Xiaobin ZHANG, Yuyao City (CN); Lin HUANG, Yuyao City (CN)

(73) Assignee: ZHEJIANG SUNNY OPTICS CO., LTD., Yuyao City (CN)

(21) Appl. No.: 19/419,989

(22) Filed: Dec. 15, 2025

(30) Foreign Application Priority Data
Mar. 6, 2025 (CN) 202510265105.8

(51) Int. Cl. G02B 27/01; G02B 15/14; G02B 27/00; G02C 7/08

(52) U.S. Cl. CPC G02B 27/0172; G02B 15/1421; G02B 27/0075; G02C 7/081; G02B 2027/0152; G02B 27/0176

(57) ABSTRACT

A visual system includes, in order from a first side to a second side along an optical axis, a first lens, a reflective polarizing element, a quarter-wave plate, a second lens, a third lens and a partially reflective element, wherein the third lens is movable to approach or move away from a display located on the second side. The system satisfies 0.05<f3/fz<2.35, 1.28≤f3/(fm+fn)≤4.85, and 0.19≤ΔL/CT3≤0.86, where f3 is an effective focal length of the third lens, fz is a combined focal length of the first lens, the reflective polarizing element, the quarter-wave plate, and the second lens, fm and fn are effective focal lengths of the system in the first and second states, respectively, ΔL is a distance by which the third lens moves when the system switches from a first state to a second state, and CT3 is a center thickness of the third lens.

### CROSS-REFERENCE TO RELATED APPLICATIONS

The present application claims the priority of Chinese patent application No. 202510265105.8, filed on Mar. 6, 2025, which is hereby incorporated by reference in its entirety.

### TECHNICAL FIELD

The present application relates to the field of optical elements, and more particularly, to a visual system.

### BACKGROUND

Virtual reality (VR) technology provides users with an immersive experience and can be applied in a wide range of fields, including education, entertainment, healthcare and so on. It has numerous advantages, such as enhancing learning effects, providing immersive entertainment experiences, and assisting treatment. The VR market holds promising prospects and is expected to continue growing, encompassing multiple fields, including the consumer, enterprise, and healthcare markets. However, wearing glasses is common among current VR users, and many VR devices are not compatible with glasses, which results in significant inconvenience for users. Therefore, it is necessary to design and develop an adjustable-focus visual system so that users with different eyesight can enjoy the VR experience without wearing glasses. In addition, lighter weight, smaller volume, and better machining and manufacturing performance are also directions of continuous development for visual systems in current VR devices.

### SUMMARY

The present application provides a visual system. The visual system may comprise, in order from a first side to a second side along an optical axis: a first lens having a positive refractive power, with a first side surface being convex; a reflective polarizing element; a quarter-wave plate; a second lens having a positive refractive power or a negative refractive power; a third lens having a positive refractive power, with a second side surface being convex; and a partially reflective element; wherein the third lens is configured to be able to move along the optical axis to approach or move away from a display located on the second side, so that the visual system switches between a first state and a second state; the visual system may satisfy conditional expressions of 0.05<f3/fz<2.35, 1.28≤f3/(fm+fn)≤4.85 and 0.19≤ΔL/CT3≤0.86; where f3 is an effective focal length of the third lens, fz is a combined focal length of the first lens, the reflective polarizing element, the quarter-wave plate, and the second lens, fm is an effective focal length of the visual system in the first state, fn is the effective focal length of the visual system in the second state, ΔL is a distance by which the third lens moves along the optical axis in a process of the visual system switching from the first state to the second state, and CT3 is a center thickness of the third lens on the optical axis.

In an implementation, a center thickness CT1 of the first lens on the optical axis, a center thickness CT2 of the second lens on the optical axis, and an amount of change Δf in the effective focal length of the visual system when switching from the first state to the second state may satisfy: 3.51≤(CT1+CT2)/Δf≤18.12.

In an implementation, the effective focal length fm of the visual system in the first state, a distance T23m on the optical axis from a second side surface of the second lens to a first side surface of the third lens in the first state of the visual system and a distance T23n on the optical axis from the second side surface of the second lens to the first side surface of the third lens in the second state of the visual system may satisfy: 2.75≤fm/(T23m+T23n)≤12.63.

In an implementation, a radius of curvature R5 of a first side surface of the third lens, a radius of curvature R4 of a second side surface of the second lens, and the distance ΔL by which the third lens moves along the optical axis in a process of the visual system switching from the first state to the second state may satisfy: 0.85 mm≤|R5/R4|×ΔL≤4.08 mm.

In an implementation, a radius of curvature R1 of the first side surface of the first lens, a distance TDm on the optical axis from the first side surface of the first lens to the second side surface of the third lens in the first state of the visual system, and a distance TDn on the optical axis from the first side surface of the first lens to the second side surface of the third lens in the second state of the visual system may satisfy: 1.7<R1/(TDm+TDn)<2.1.

In an implementation, an effective focal length f1 of the first lens, an effective focal length f2 of the second lens, and an amount of change Δf in the effective focal length of the visual system when switching from the first state to the second state may satisfy: 0.45 mm≤|f1/f2|×Δf≤0.82 mm.

In an implementation, the effective focal length f3 of the third lens, and a distance TDm on the optical axis from the first side surface of the first lens to the second side surface of the third lens in the first state of the visual system may satisfy: 2.7<f3/TDm<10.9.

In an implementation, the center thickness CT3 of the third lens on the optical axis, a distance BFLm on the optical axis from the second side surface of the third lens to the display in the first state of the visual system, and a distance BFLn on the optical axis from the second side surface of the third lens to the display in the second state of the visual system may satisfy: 0.55<CT3/(BFLm+BFLn)<3.05.

In an implementation, a radius of curvature R6 of the second side surface of the third lens and a distance TDn on the optical axis from the first side surface of the first lens to the second side surface of the third lens in the second state of the visual system may satisfy: −7.57≤R6/TDn≤−4.57.

In an implementation, the effective focal length fm of the visual system in the first state, the effective focal length fn of the visual system in the second state, and an entrance pupil diameter EPD of the visual system may satisfy: 4.15< (fm+fn)/EPD<5.6.

In an implementation, a center thickness CT2 of the second lens on the optical axis, a center thickness CTR of the reflective polarizing element on the optical axis, a center thickness CTQ of the quarter-wave plate on the optical axis, and a distance T23m on the optical axis from a second side surface of the second lens to a first side surface of the third lens in the first state of the visual system may satisfy: 0.65< (CT2+CTR+CTQ)/T23m<4.35.

In an implementation, a distance BFLn on the optical axis from the second side surface of the third lens to the display in the second state of the visual system and a refractive index N3 of the third lens may satisfy: 0.70 mm≤BFLn/N3≤2.51 mm.

In an implementation, a radius of curvature R1 of the first side surface of the first lens and the effective focal length fn of the visual system in the second state may satisfy: 3.0<R1/fn<3.55.

In an implementation, a distance TDm on the optical axis from the first side surface of the first lens to the second side surface of the third lens in the first state of the visual system, and a center thickness CT1 of the first lens on the optical axis may satisfy: 3.09≤TDm/CT1≤5.40.

In an implementation, an effective focal length f1 of the first lens, a dispersion coefficient V1 of the first lens, and the distance ΔL by which the third lens moves along the optical axis in a process of the visual system switching from the first state to the second state may satisfy: 0.66≤(f1/V1)/ΔL≤1.66.

The present application discloses a visual system. The visual system comprises, in order from a first side to a second side along an optical axis, a first lens, a reflective polarizing element, a quarter-wave plate, a second lens, a third lens and a partially reflective element, wherein the first lens has a positive refractive power, with a first side surface being convex; the second lens has a positive refractive power or a negative refractive power; the third lens has a positive refractive power, with a second side surface being convex; the third lens is configured to be able to move along the optical axis to approach or move away from a display located on the second side, so that the visual system switches between a first state and a second state; an effective focal length f3 of the third lens and a combined focal length fz of the first lens, the reflective polarizing element, the quarter-wave plate and the second lens satisfy a conditional expression of 0.05<f3/fz<2.35; the effective focal length f3 of the third lens, an effective focal length fm of the visual system in the first state and an effective focal length fn of the visual system in the second state satisfy a conditional expression of 1.28≤f3/(fm+fn)≤4.85; a distance ΔL by which the third lens moves along the optical axis in a process of the visual system switching from the first state to the second state and a center thickness CT3 of the third lens on the optical axis satisfy a conditional expression of 0.19≤ΔL/CT3≤0.86. By reasonably configuring the visual system, in the case that the conditional expression of 0.05<f3/fz<2.35 is satisfied, while also controlling to satisfy the conditional expressions of 1.28≤f3/(fm+fn)≤4.85 and 0.19≤ΔL/CT3≤0.86, this helps control the influences of lens movement on the focal length and imaging quality of the system, ensuring the focus adjustment precision and stability of the system in different states, and improving the accuracy and clarity of imaging.

The visual system provided according to the present application adopts a three-piece fold-back system. By moving the third lens, the system can switch between different states, enabling the system to achieve continuous zooming in the range of −5D to +2D, for example, to meet the needs of users with different eyesight, so that the users with different eyesight can enjoy the VR experience without wearing glasses, thereby improving user comfort and convenience. Furthermore, it has the characteristics of small volume, light weight, high imaging quality, etc., which improves the optical performance of the system.

### BRIEF DESCRIPTION OF THE DRAWINGS

Other features, objectives, and advantages of the present application will become more apparent from the following detailed description of non-restrictive embodiments with reference to the drawings. In the drawings:

FIG. 1 shows a schematic structural diagram of a visual system according to Embodiment 1 of the present application when it is in a first state (+2D state);

FIG. 2 shows an MTF (Modulation Transfer Function) curve of the visual system of Embodiment 1 when it is in the first state (+2D state);

FIG. 3 shows a schematic structural diagram of the visual system according to Embodiment 1 of the present application when it is in a second state (−5D state);

FIG. 4 shows an MTF curve of the visual system of Embodiment 1 when it is in the second state (−5D state);

FIG. 5 shows a schematic structural diagram of a visual system according to Embodiment 2 of the present application when it is in a first state (+2D state);

FIG. 6 shows an MTF curve of the visual system of Embodiment 2 when it is in the first state (+2D state);

FIG. 7 shows a schematic structural diagram of the visual system according to Embodiment 2 of the present application when it is in a second state (−5D state);

FIG. 8 shows an MTF curve of the visual system of Embodiment 2 when it is in the second state (−5D state);

FIG. 9 shows a schematic structural diagram of a visual system according to Embodiment 3 of the present application when it is in a first state (+2D state);

FIG. 10 shows an MTF curve of the visual system of Embodiment 3 when it is in the first state (+2D state);

FIG. 11 shows a schematic structural diagram of the visual system according to Embodiment 3 of the present application when it is in a second state (−5D state);

FIG. 12 shows an MTF curve of the visual system of Embodiment 3 when it is in the second state (−5D state);

FIG. 13 shows a schematic structural diagram of a visual system according to Embodiment 4 of the present application when it is in a first state (+2D state);

FIG. 14 shows an MTF curve of the visual system of Embodiment 4 when it is in the first state (+2D state);

FIG. 15 shows a schematic structural diagram of the visual system according to Embodiment 4 of the present application when it is in a second state (−5D state);

FIG. 16 shows an MTF curve of the visual system of Embodiment 4 when it is in the second state (−5D state).

### DETAILED DESCRIPTION

In order to better understand the present application, various aspects of the present application will be described in more detail with reference to the drawings. It should be understood that the detailed description is merely a representation of exemplary implementations of the present application, and does not limit the scope of the present application in any way. Throughout the specification, identical reference signs refer to identical elements. The expression “and/or” includes any and all combinations of one or more of the associated listed items.

It should be noted that in the present description, the expressions of “first,” “second,” etc., are only used to distinguish one feature from another feature, and do not indicate any limitation on the feature. Therefore, without departing from the teachings of the present application, a first lens to be discussed below may also be referred to as a second lens, and the second lens may also be referred to as the first lens.

In the drawings, for convenience of explanation, the thickness, size, and shape of the respective lens have been slightly exaggerated. Specifically, the shapes of spherical or aspherical surfaces shown in the drawings are shown by way of example. That is, the shapes of the spherical or aspherical surfaces are not limited to those shown in the drawings. The drawings are only examples and are not drawn strictly to scale.

Herein, a paraxial region refers to a region near an optical axis. If a lens surface exhibits a convex surface and the position of the convex surface is not defined, then it means that the lens surface is convex at least in the paraxial region; and if a lens surface exhibits a concave surface and the position of the concave surface is not defined, then it means that the lens surface is concave at least in the paraxial region.

It should also be understood that the terms “comprising”, “comprise”, “having”, “including” and/or “include” when used in the present description, indicate the existence of stated features, elements and/or components, but does not exclude the presence or addition of one or more other features, elements, components and/or combinations thereof. Furthermore, when an expression such as “at least one of” appears after a list of listed features, it modifies the entire list of features, rather than individual elements in the list. In addition, when an implementation of the present application is described, “may” is used to indicate “one or more implementations of the present application”. Also, the term “exemplary” is intended to refer to an example or illustration.

Unless otherwise defined, all terms (including technical and scientific terms) used herein have the same meanings as commonly understood by those of ordinary skill in the art to which the present application belongs. It should also be understood that the terms (such as those defined in commonly used dictionaries) should be interpreted to have meanings consistent with their meanings in the context of the relevant art and will not be interpreted in an idealized or overly formal sense unless it is clearly defined herein.

It should be noted that, in the case of no conflict, the embodiments in the present application and the features in the embodiments may be combined with each other. The present application will be described in detail below in conjunction with embodiments with reference to the drawings.

The features, principles and other aspects of the present application will be described in detail below.

A visual system according to an exemplary embodiment of the present application may include a first lens, a reflective polarizing element, a quarter-wave plate, a second lens, a third lens and a partially reflective element. In an exemplary implementation, the first lens, the reflective polarizing element, the quarter-wave plate, the second lens, the third lens, and the partially reflective element may be arranged in order from a first side to a second side along an optical axis.

In an exemplary implementation, the first lens may have a positive refractive power, and a first side surface which may exhibit a convex surface.

In an exemplary implementation, the second lens may have a positive refractive power or a negative refractive power.

In an exemplary implementation, the third lens may have a positive refractive power, and a second side surface which may exhibit a convex surface.

In an exemplary implementation, the reflective polarizing element may be disposed on or attached to a second side surface of the first lens; and the quarter-wave plate may be disposed on or attached to a second side surface of the reflective polarizing element. As an example, a first side surface of the reflective polarizing element may be at least partially in contact with the second side surface of the first lens. a first side surface of the quarter-wave plate may be at least partially in contact with the second side surface of the reflective polarizing element.

In an exemplary implementation, the first lens and the second lens may form a cemented lens. Specifically, the first lens, the reflective polarizing element, the quarter-wave plate, and the second lens may form a cemented lens. As an example, the first side surface of the reflective polarizing element may be at least partially in contact with the second side surface of the first lens; the first side surface of the quarter-wave plate may be at least partially in contact with the second side surface of the reflective polarizing element; and the first side surface of the second lens may be at least partially in contact with the second side surface of the quarter-wave plate.

In an exemplary implementation, the partially reflective element may be disposed on the second side surface of the third lens. As an example, the partially reflective element may be a partially transmissive and partially reflective film layer coated on the second side surface of the third lens.

By reasonably setting the structure of the visual system, the light path can be folded, and the body length of the visual system can be effectively shortened, reducing the volume and weight of the visual system, and making the visual system lightweight and portable. The configuration of the cemented lens provides the system with a high-quality lens material that has advantages such as lightness, excellent light transmittance, and wear resistance, which may make it more suitable for lens element manufacturing in VR devices, and may improve the quality and adaptability of lens elements.

In an exemplary implementation, the first side may be, for example, a human eye side, and the second side may be, for example, a display side. The visual system may be used in, for example, a VR device, etc.

In an exemplary implementation, the respective distances, on the optical axis, of the first lens and the second lens as well as the reflective polarizing element and the quarter-wave plate to the display or image plane on the second side of the visual system may be fixed. The third lens may be configured to be able to move along the optical axis to approach or move away from the display or image plane on the second side of the visual system, so that the visual system switches between the first state and the second state. Specifically, when the third lens moves to a position closest to the display or image plane, the distance on the optical axis between the third lens and the second lens is the largest, and the visual system may be in a +2D state, namely, the first state; when the third lens moves to a position farthest from the display or image plane, the distance on the optical axis between the third lens and the second lens is the smallest, and the visual system may be in a −5D state, namely, the second state.

As an example, when the visual system is in the first state, the diopter of the visual system is +2D, which is suitable for users with a +2D diopter, for example; when the visual system is in the second state, the diopter of the visual system is −5D, which is suitable for users with a −5D diopter, for example. When the sign of the diopter is a negative sign, it may indicate that the user is a myopic user; when the sign of the diopter is a positive sign, it may indicate that the user is a hyperopic user; the specific value of the diopter may indicate the user's diopter degree. For example, a +1D diopter may indicate that the user's hyperopia is approximately 100 degrees, and a −1D diopter may indicate that the user's myopia is approximately 100 degrees.

It should be understood that in addition to the first state and the second state, the visual system according to the implementation of the present application may also have other states, such as between −5D and +2D. The visual system according to the implementation of the present application can achieve continuous zooming in the range of −5D to +2D, which can satisfy the needs of users with different eyesight and enable users to enjoy the VR experience without wearing glasses.

In an exemplary implementation, the visual system of the present application may include at least one stop (aperture stop). The stop may constrain the light path and control the magnitude of light intensity. The stop may be disposed at an appropriate position in the visual system. For example, the stop may be located between the first side (e.g., a human eye side) and the first lens.

In an exemplary implementation, the visual system has different virtual image distances (VID) in the first and second states. The VID may be, for example, the distance from a virtual image formed by image light from the second side at a predetermined position to the stop on the optical axis. In this context, VID=1000/diopter.

The visual system will be described below with reference to FIG. 1. As shown in FIG. 1, the visual system according to an exemplary implementation of the present application may include a first lens E1, a reflective polarizing element RP, a quarter-wave plate QWP, a second lens E2, a third lens E3, and a partially reflective element BS arranged in order from a first side to a second side. The reflective polarizing element RP is disposed on a second side surface of the first lens E1, and the quarter-wave plate QWP is disposed on a second side surface of the reflective polarizing element RP. Meanwhile, a second side surface of the quarter-wave plate QWP is attached to a first side surface of the second lens. That is, the first lens E1, the second lens E2, and the reflective polarizing element RP and the quarter-wave plate QWP located therebetween form a cemented lens. In actual use, the visual system according to an exemplary implementation of the present application may be used as a VR lens assembly, for example. In this case, the first side corresponds to a human eye side and the second side corresponds to a display or image plane side. The second side of the visual system also has, for example, a display or an image plane IMG. A light beam emitted from the IMG may sequentially pass through the partially reflective element BS, the third lens E3, the second lens E2, and the quarter-wave plate QWP to reach the reflective polarizing element RP. The light beam is reflected at the reflective polarizing element RP and again passes through the quarter-wave plate QWP, the second lens E2, and the third lens E3 to reach the partially reflective element BS. Thereafter, the light beam is again reflected at the partially reflective element BS and sequentially passes through the third lens E3, the second lens E2, the quarter-wave plate QWP, the reflective polarizing element RP, and the first lens E1 to exit toward the first side (e.g., a stop STO in FIG. 1). The visual system provided by the present application folds the required optical path without affecting projection quality by means of a combination of light reflection and refraction, effectively shortening the body length of the visual system.

In an exemplary implementation, the visual system of the present application may satisfy a conditional expression of 0.05<f3/fz<2.35, where f3 is an effective focal length of the third lens, and fz is a combined focal length of the first lens, the reflective polarizing element, the quarter-wave plate, and the second lens.

In an exemplary implementation, the visual system of the present application may satisfy a conditional expression of 1.28≤f3/(fm+fn)≤4.85, where f3 is the effective focal length of the third lens, fm is an effective focal length of the visual system in the +2D state, and fn is an effective focal length of the visual system in the −5D state.

In an exemplary implementation, the visual system of the present application may satisfy a conditional expression of 0.19≤ΔL/CT3≤0.86, where ΔL is a distance by which the third lens moves along the optical axis when the visual system switches from the +2D state to the −5D state, and CT3 is a center thickness of the third lens on the optical axis.

A visual system according to an exemplary implementation of the present application includes, in order from a first side to a second side along an optical axis, a first lens, a reflective polarizing element, a quarter-wave plate, a second lens, a third lens and a partially reflective element, wherein the first lens has a positive refractive power, with a first side surface being convex; the second lens has a positive refractive power or a negative refractive power; the third lens has a positive refractive power, with a second side surface being convex; the third lens is configured to be able to move along the optical axis to approach or move away from a display located on the second side, so that the visual system switches between a first state and a second state; an effective focal length f3 of the third lens and a combined focal length fz of the first lens, the reflective polarizing element, the quarter-wave plate and the second lens satisfy a conditional expression of 0.05<f3/fz<2.35; the effective focal length f3 of the third lens, an effective focal length fm of the visual system in the first state and an effective focal length fn of the visual system in the second state satisfy a conditional expression of 1.28≤f3/(fm+fn)≤4.85; a distance ΔL by which the third lens moves along the optical axis in a process of the visual system switching from the first state to the second state and a center thickness CT3 of the third lens on the optical axis satisfy a conditional expression of 0.19≤ΔL/CT3≤0.86. By reasonably configuring the visual system, in the case that the conditional expression of 0.05<f3/fz<2.35 is satisfied, while controlling to satisfy the conditional expressions of 1.28≤f3/(fm+fn)≤4.85 and 0.19≤ΔL/CT3≤0.86, this helps control the influences of lens movement on the focal length and imaging quality of the system, ensuring the focus adjustment precision and stability of the system in different states, and improving the accuracy and clarity of imaging.

In an exemplary implementation, the visual system of the present application may satisfy a conditional expression of 3.51≤(CT1+CT2)/Δf≤18.12, where CT1 is a center thickness of the first lens on the optical axis, CT2 is a center thickness of the second lens on the optical axis, and Δf is an amount of change in the effective focal length of the visual system when switching from the +2D state to the −5D state, namely, the difference between the effective focal length fm of the visual system in the +2D state and the effective focal length fn of the visual system in the −5D state. By reasonably controlling this conditional expression, the design of the optical system can be optimized, ensuring stable and consistent optical performance of the system at different focal length states, and providing users with a superior virtual reality experience.

In an exemplary implementation, the visual system of the present application may satisfy a conditional expression of 2.75≤fm/(T23m+T23n)≤12.63, where fm is an effective focal length of the visual system in the +2D state, T23m is a distance on the optical axis from the second side surface of the second lens to the first side surface of the third lens when the visual system is in the +2D state, and T23n is a distance on the optical axis from the second side surface of the second lens to the first side surface of the third lens when the visual system is in the −5D state. By reasonably controlling this conditional expression, the visual system can meet certain requirements in terms of focal length control, system stability, optical path optimization and so on, providing users with better visual experience and imaging effects.

In an exemplary implementation, the visual system of the present application may satisfy a conditional expression of 0.85 mm≤|R5/R4|×ΔL≤4.08 mm, where R5 is a radius of curvature of the first side surface of the third lens, R4 is a radius of curvature of the second side surface of the second lens, and ΔL is a distance by which the third lens moves along the optical axis when the visual system switches from the +2D state to the −5D state. By reasonably controlling this conditional expression, it is helpful to ensure that the focus adjustment range of the optical system from the +2D state to the −5D state meets design requirements, thereby ensuring the focus adjustment stability and accuracy of the system.

In an exemplary implementation, the visual system of the present application may satisfy a conditional expression of 1.7<R1/(TDm+TDn)<2.1, where R1 is a radius of curvature of the first side surface of the first lens, TDm is a distance on the optical axis from the first side surface of the first lens to the second side surface of the third lens when the visual system is in the +2D state, and TDn is a distance on the optical axis from the first side surface of the first lens to the second side surface of the third lens when the visual system is in the −5D state. By reasonably controlling this conditional expression, the optical performance of the system can be optimized, improving the clarity and accuracy of imaging and reducing optical distortion; and meanwhile focus variations of the system in different states can also be reduced, ensuring the focus adjustment stability and consistency of the system.

In an exemplary implementation, the visual system of the present application may satisfy a conditional expression of 0.45 mm≤|f1/f2|×Δf≤0.82 mm, where f1 is the effective focal length of the first lens, f2 is the effective focal length of the second lens, and Δf is the amount of change in the effective focal length of the visual system when switching from the +2D state to the −5D state. By reasonably controlling this conditional expression, it helps ensure that the range of focal length variation in different states meets design requirements, ensuring the focus adjustment stability and accuracy; and meanwhile the focus adjustment performance of the system can also be optimized, improving the clarity and accuracy of imaging, and reducing optical distortion during focus adjustment.

In an exemplary implementation, the visual system of the present application may satisfy a conditional expression of 2.7<f3/TDm<10.9, where f3 is the effective focal length of the third lens, and TDm is the distance on the optical axis from the first side surface of the first lens to the second side surface of the third lens when the visual system is in the +2D state. By reasonably controlling this conditional expression, the imaging quality of the system can be optimized, reducing optical issues such as spherical aberration and astigmatism; and this also helps ensure the proper focal length setting of the system, and can improve the focus adjustment precision of the optical system, improving the clarity and accuracy of imaging.

In an exemplary implementation, the visual system of the present application may satisfy a conditional expression of 0.55<CT3/(BFLm+BFLn)<3.05, where CT3 is a center thickness of the third lens on the optical axis, BFLm is a distance on the optical axis from the second side of the third lens to the display when the visual system is in the +2D state, and BFLn is a distance on the optical axis from the second side of the third lens to the display when the visual system is in the −5D state. By reasonably controlling this conditional expression, it helps maintain the balance and stability among the optical elements of the system, reducing aberrations and distortion in the optical system, and improving the quality and clarity of imaging; and meanwhile the optical path can also be optimized, improving the imaging performance and efficiency of the system.

In an exemplary implementation, the visual system of the present application may satisfy a conditional expression of −7.57≤R6/TDn≤−4.57, where R6 is a radius of curvature of the second side surface of the third lens, and TDn is a distance on the optical axis from the first side surface of the first lens to the second side surface of the third lens when the visual system is in the −5D state. By reasonably controlling this conditional expression, it can be ensured that the optical system meets certain requirements in terms of aberration control, optical system optimization, distortion reduction, and improved image quality, providing users with better visual experience and imaging effects.

In an exemplary implementation, the visual system of the present application may satisfy a conditional expression of 4.15< (fm+fn)/EPD<5.6, where fm is an effective focal length of the visual system in the +2D state, fn is an effective focal length of the visual system in the −5D state, and EPD is an entrance pupil diameter of the visual system. By reasonably controlling this conditional expression, it can be ensured that the system maintains consistent imaging quality at different focal length states, so that whether viewing from close up or from a distance, users can obtain clear and accurate images, improving visual experience and comfort; and meanwhile visual fatigue, glare, and other discomforts can also be reduced, further improving user comfort.

In an exemplary implementation, the visual system of the present application may satisfy a conditional expression of 0.65< (CT2+CTR+CTQ)/T23m<4.35, where CT2 is a center thickness of the second lens element on the optical axis, CTR is a center thickness of the reflective polarizing element on the optical axis, CTQ is a center thickness of the quarter-wave plate on the optical axis, and T23m is a distance on the optical axis from the second side surface of the second lens element to the first side surface of the third lens element when the visual system is in the +2D state. By reasonably controlling this conditional expression, optical interference and also interference sources can be reduced, improving the system stability and reliability; it can also help reduce issues such as scattering and reflection in the optical system, improving the quality and clarity of imaging, thereby providing users with clearer and more comfortable visual effects, so that the user experience is more pleasant and comfortable.

In an exemplary implementation, the visual system of the present application may satisfy a conditional expression of 0.70 mm≤BFLn/N3≤2.51 mm, where BFLn is a distance on the optical axis from the second side surface of the third lens to the display when the visual system is in the −5D mode, and N3 is the refractive index of the third lens. By reasonably controlling this conditional expression, variations of the optical system in different operating states can be reduced, ensuring the system stability and reliability. The system can adjust the parameters of the third lens as needed to adapt to different application scenarios and requirements, providing a more flexible optical solution.

In an exemplary implementation, the visual system of the present application may satisfy a conditional expression of 3.0<R1/fn<3.55, where R1 is a radius of curvature of the first side surface of the first lens, and fn is an effective focal length of the visual system in the −5D mode. By reasonably controlling this conditional expression, the focal length and imaging characteristics of the system can be adjusted, improving the optical performance and efficiency of the system. Meanwhile, clear and accurate imaging helps reduce visual fatigue and improve user experience and comfort.

In an exemplary implementation, the visual system of the present application may satisfy a conditional expression of 3.09≤TDm/CT1≤5.40, where TDm is a distance on the optical axis from the first side surface of the first lens to the second side surface of the third lens when the visual system is in the +2D mode, and CT1 is a center thickness of the first lens on the optical axis. By reasonably controlling this conditional expression, optical issues such as astigmatism and spherical aberration can be reduced, improving the imaging quality and color accuracy; and it also helps reduce variations of the optical system in different operating states, ensuring the system stability and reliability.

In an exemplary implementation, the visual system of the present application may satisfy a conditional expression of 0.66≤(f1/V1)/ΔL≤1.66, where f1 is an effective focal length of the first lens, V1 is a dispersion coefficient of the first lens, and ΔL is a distance by which the third lens moves along the optical axis when the visual system switches from the +2D state to the −5D state. By reasonably controlling this conditional expression, it helps optimize the color correction capabilities of the system, reduce chromatic aberration and dispersion, improve the color accuracy and consistency of imaging, and ensure that the color quality of imaging meets requirements.

In the visual system according to the implementations of the present application, one or more aspherical lenses may be included in the first lens, the second lens, and the third lens. The aspherical lenses have better curvature radius characteristics and have the advantages of ameliorating distortion aberration and ameliorating astigmatism aberration. After using the aspherical lenses, the aberrations that occur during imaging can be eliminated as much as possible, thereby improving the imaging quality.

In one aspect, a visual system according to an exemplary implementation of the present application includes, in order from a first side to a second side along an optical axis, a first lens, a reflective polarizing element, a quarter-wave plate, a second lens, a third lens and a partially reflective element, wherein the first lens has a positive refractive power, with a first side surface being convex; the second lens has a positive refractive power or a negative refractive power; the third lens has a positive refractive power, with a second side surface being convex; the third lens is configured to be able to move along the optical axis to approach or move away from a display located on the second side, so that the visual system switches between a first state and a second state; an effective focal length f3 of the third lens and a combined focal length fz of the first lens, the reflective polarizing element, the quarter-wave plate and the second lens satisfy a conditional expression of 0.05<f3/fz<2.35; the effective focal length f3 of the third lens, an effective focal length fm of the visual system in the first state and an effective focal length fn of the visual system in the second state satisfy a conditional expression of 1.28≤f3/(fm+fn)≤4.85; a distance ΔL by which the third lens moves along the optical axis in a process of the visual system switching from the first state to the second state and a center thickness CT3 of the third lens on the optical axis satisfy a conditional expression of 0.19≤ΔL/CT3<0.86. By reasonably configuring the visual system, in the case that the conditional expression of 0.05<f3/fz<2.35 is satisfied, while controlling to satisfy the conditional expressions of 1.28≤f3/(fm+fn)≤4.85 and 0.19≤ΔL/CT3≤0.86, this helps control the influences of lens movement on the focal length and imaging quality of the system, ensuring the precision and stability of the focus adjustment of the system in different states, and improving imaging accuracy and clarity.

In another aspect, a visual system according to an exemplary implementation of the present application includes, in order from a first side to a second side along an optical axis, a first lens, a reflective polarizing element, a quarter-wave plate, a second lens, a third lens and a partially reflective element, wherein the first lens has a positive refractive power, with a first side surface being convex; the second lens has a positive refractive power or a negative refractive power; the third lens has a positive refractive power, with a second side surface being convex; the third lens is configured to be able to move along the optical axis to approach or move away from a display located on the second side, so that the visual system switches between a first state and a second state; an effective focal length f3 of the third lens and a combined focal length fz of the first lens, the reflective polarizing element, the quarter-wave plate and the second lens satisfy a conditional expression of 0.05<f3/fz<2.35; the effective focal length f3 of the third lens, an effective focal length fm of the visual system in the first state and an effective focal length fn of the visual system in the second state satisfy a conditional expression of 1.28≤f3/(fm+fn)≤4.85; a radius of curvature R5 of a first side surface of the third lens, a radius of curvature R4 of a second side surface of the second lens, and the distance ΔL by which the third lens moves along the optical axis when the visual system switches from a +2D state to a −5D state may satisfy a conditional expression of 0.85 mm≤|R5/R4|×ΔL≤4.08 mm. By reasonably configuring the visual system, in the case that the conditional expression of 0.05<f3/fz<2.35 is satisfied, while controlling to satisfy the conditional expressions of 1.28≤f3/(fm+fn)≤4.85 and 0.85 mm≤|R5/R4|×ΔL≤4.08 mm, it helps ensure that the focus adjustment range of the optical system from the +2D state to the −5D state meets design requirements, thereby ensuring the stability and accuracy of the system's focus adjustment.

The visual system according to the exemplary implementation of the present application adopts, for example, a three-piece fold-back structure. Through the reasonable configuration of the system structure and parameters, it can not only reduce the total optical length and the system weight, realizing the miniaturization and lightweight of the system, and improving the user comfort; but can also realize zooming in the range of −5D to +2D through the movement of the third lens, satisfying the needs of users with different eyesight, so that users can enjoy the VR experience without wearing glasses. Meanwhile, the focus adjustment precision and stability of the system in different states can be ensured, improving the accuracy and clarity of imaging, and making the system have higher and more stable optical performance. In addition, the use of the cemented lens in the system has got the advantages of lightness, good light transmittance, wear resistance, etc., which is more suitable for lens element manufacturing of VR devices, thereby improving the quality and adaptability of the lens elements.

In addition, the present application further provides a VR device. The VR device may include the visual system provided by any of the above-mentioned implementations, wherein the first side may be a human eye side, and the second side may be a display/image plane side. The VR device can achieve continuously zooming in the range of −5D to +2D, enabling users with different eyesight conditions to clearly enjoy the VR experience without wearing glasses, and the VR device also has the characteristics of miniaturization, lightweight, high clarity, and high stability, thereby improving the user experience.

Specific embodiments of the visual system applicable to the above-mentioned implementations will be further described below with reference to the drawings.

### Embodiment 1

A visual system according to Embodiment 1 of the present application will be described below with reference to FIGS. 1 to 4.

The visual system according to Embodiment 1 of the present application includes, in order from a first side to a second side along an optical axis, a first lens E1, a reflective polarizing element RP, a quarter-wave plate QWP, a second lens E2, a third lens E3, and a partially reflective element BS. The first lens E1 has a positive refractive power, with a first side surface being convex and a second side surface being planar; the second lens E2 has a positive refractive power, with a first side surface being planar and a second side surface being convex; the third lens E3 has a positive refractive power, with a first side surface being concave and a second side surface being convex; the reflective polarizing element RP is disposed on the second side surface of the first lens E1, and the quarter-wave plate QWP is disposed on a second side surface of the reflective polarizing element RP. Meanwhile, a second side surface of the quarter-wave plate QWP is attached to a first side surface of the second lens. That is, the first lens E1, the second lens E2, and the reflective polarizing element RP and the quarter-wave plate QWP located therebetween form a cemented lens.

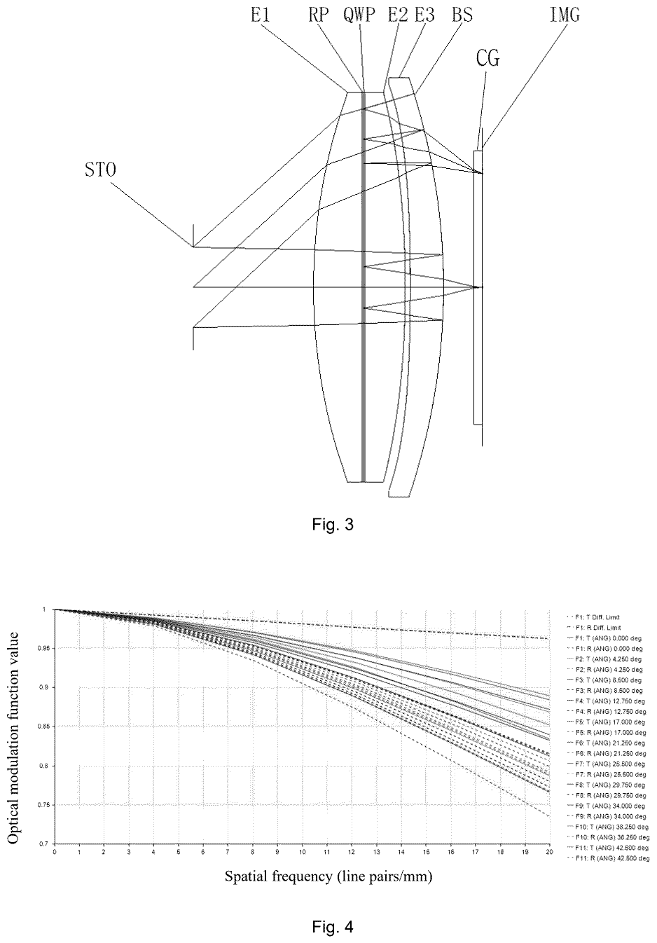

In this example, a stop STO may be provided on the first side of the visual system, and a display/image plane IMG may be provided on the second side of the visual system. The respective distances, along the optical axis, of the first lens E1, the reflective polarizing element RP, the quarter-wave plate QWP, and the second lens E2 to the display/image plane IMG are relatively fixed. The third lens E3 and the partially reflective element BS may be moved along the optical axis to approach or move away from the display/image plane IMG. During this process, the visual system can achieve zooming in the range of −5D to +2D. FIG. 1 shows a schematic structural diagram of the visual system when the third lens E3 and the partially reflective element BS are moved along the optical axis to a position closest to the display/image plane IMG. In this case, the visual system is in a +2D state. FIG. 3 shows a schematic structural diagram of the visual system when the third lens E3 and the partially reflective element BS are moved along the optical axis to a position farthest from the display/image plane IMG. In this case, the visual system is in a −5D state.

As shown in FIGS. 1 and 3, in a specific application of the visual system according to this example, image light, for example, from the display/image plane IMG, may sequentially pass through the partially reflective element BS, the third lens E3, the second lens E2, and the quarter-wave plate QWP to reach the reflective polarizing element RP. Then, the light is reflected by the reflective polarizing element RP and again passes through the quarter-wave plate QWP, the second lens E2, and the third lens E3 before reaching the partially reflective element BS. Thereafter, the light is reflected again by the partially reflective element BS and sequentially passes through the third lens E3, the second lens E2, the quarter-wave plate QWP, the reflective polarizing element RP, and the first lens E1 to the stop, ultimately forming an image at a predetermined position. For example, in this visual system, the light after these two reflections may ultimately be projected onto a user's pupil.

Table 1 shows the basic parameters of the visual system of Embodiment 1, wherein the units of the radius of curvature and thickness/distance are all in millimeters (mm).

TABLE 1

| | | | Radius of | Thickness/ | Refractive | Dispersion | Refraction/ | Cone |
|---|---|---|---|---|---|---|---|---|
| Surface | Element | Surface type | curvature | distance | index | coefficient | reflection | coefficient |
| S0 | | Spherical | Infinite | D1 | | | Refraction | |
| S1 | | Spherical | Infinite | 0.0000 | | | Refraction | |
| S2 | Stop (STO) | Spherical | Infinite | 12.0000 | | | Refraction | |
| S3 | First lens (E1) | Aspherical | 57.3525 | 4.8327 | 1.551 | 56.30 | Refraction | −0.3176 |
| S4 | Reflective polarizing | Spherical | Infinite | 0.1180 | 1.487 | 57.47 | Refraction | |
| | element (RP) | | | | | | | |
| S5 | Quarter-wave plate | Spherical | Infinite | 0.1340 | 1.487 | 57.47 | Refraction | |
| | (QWP) | | | | | | | |
| S6 | Second lens (E2) | Spherical | Infinite | 4.0461 | 1.551 | 56.30 | Refraction | |
| S7 | | Aspherical | −108.7162 | D2 | | | Refraction | 6.2155 |
| S8 | Third lens (E3) | Aspherical | −222.2712 | 3.3076 | 1.551 | 56.30 | Refraction | 96.7299 |
| S9 | Partially reflective | Aspherical | −64.1409 | −3.3076 | 1.551 | 56.30 | Reflection | −0.9418 |
| | element (BS) | | | | | | | |
| S10 | | Aspherical | −222.2712 | D3 | | | Refraction | 96.7299 |
| S11 | | Aspherical | −108.7162 | −4.0461 | 1.551 | 56.30 | Refraction | 6.2155 |
| S12 | | Spherical | Infinite | −0.1340 | 1.487 | 57.47 | Refraction | |
| S13 | Reflective polarizing | Spherical | Infinite | 0.1340 | 1.487 | 57.47 | Reflection | |
| | element (RP) | | | | | | | |
| S14 | Second lens (E2) | Spherical | Infinite | 4.0461 | 1.551 | 56.30 | Refraction | |
| S15 | | Aspherical | −108.7162 | D4 | | | Refraction | 6.2155 |
| S16 | Third lens (E3) | Aspherical | −222.2712 | 3.3076 | 1.551 | 56.30 | Refraction | 96.7299 |
| S17 | | Aspherical | −64.1409 | D5 | | | Refraction | −0.9418 |
| S18 | | Spherical | Infinite | 0.9000 | 1.519 | 64.17 | Refraction | |
| S19 | | Spherical | Infinite | 0.0000 | | | Refraction | |
| S20 | Image plane (IMG) | Spherical | Infinite | 0.0000 | | | Refraction | |

Parameters D1 to D5 in Table 1 can be understood as follows: D5 can be understood as a value taken along the optical axis from a first side surface of a filter and/or protective glass CG disposed on the first side of the image plane IMG to the second side surface of the third lens E3; D4 can be understood as a value taken along the optical axis from the first side surface of the third lens E3 to the second side surface of the second lens E2; D3 can be understood as a value taken along the optical axis from the second side surface of the second lens E2 to the first side surface of the third lens E3; D2 can be understood as a value taken along the optical axis from the first side surface of the third lens E3 to the second side surface of the second lens E2 again; and D1 can be understood as a value of the virtual image distance of the visual system according to this embodiment. During zooming of the visual system according to this embodiment by moving the third lens E3 and the partially reflective element BS along the optical axis, the values of these parameters D1 to D5 all change accordingly. The values of parameters D1 to D5 for the visual system in the +2D state shown in FIG. 1 and the −5D state shown in FIG. 3 are shown in Table 2 below.

TABLE 2

| | D1 | D2 | D3 | D4 | D5 |
|---|---|---|---|---|---|
| +2D state | 500.0000 | 2.4964 | −2.4964 | 2.4964 | 1.0000 |
| −5D state | −200.0000 | 0.5000 | −0.5000 | 0.5000 | 2.9964 |

In this embodiment, the first side surface S3 of the first lens E1, the second side surface S7 of the second lens E2, and the first side surface S16 and the second side surface S17 of the third lens E3 are all aspherical surfaces. The surface profile of each aspherical lens can be defined by, but is not limited to, the following aspherical surface formula:

$$x = \frac{{ch}^{2}}{1 + 1 - ( k + 1 ) {c}^{2} {h}^{2}} + \sum A i {h}^{i} \qquad ( 1 )$$

Where x is a distance vector height from a vertex of the aspherical surface when the aspherical surface is at a height of h along the direction of the optical axis; c is paraxial curvature of the aspherical surface, c=1/R (that is, the paraxial curvature c is the reciprocal of the radius of curvature R in Table 1 above); k is a conic coefficient; and Ai is a correction coefficient of an i-th order of the aspherical surface. Higher-order coefficients A₄, A₆, A₈, A₁₀, A₁₂, A₁₄, A₁₆, A₁₈, and A₂₀ that can be used for each of the aspherical lens surfaces S3, S7 and S16-S17 in this embodiment are given in Table 3 below.

TABLE 3

| Co- | | | | |
|---|---|---|---|---|
| effi- | surface | | | |
| cient | S3 | S7 | S16 | S17 |
| A4 | 1.0169E−06 | −3.9431E−06 | −5.9739E−06 | −2.1109E−07 |
| A6 | −4.2055E−09 | 5.7408E−09 | 2.4408E−09 | −2.7191E−10 |
| A8 | 8.4694E−12 | −3.2742E−12 | −3.9160E−13 | 1.0511E−12 |
| A10 | 0.0000E+00 | 0.0000E+00 | 0.0000E+00 | 0.0000E+00 |
| A12 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

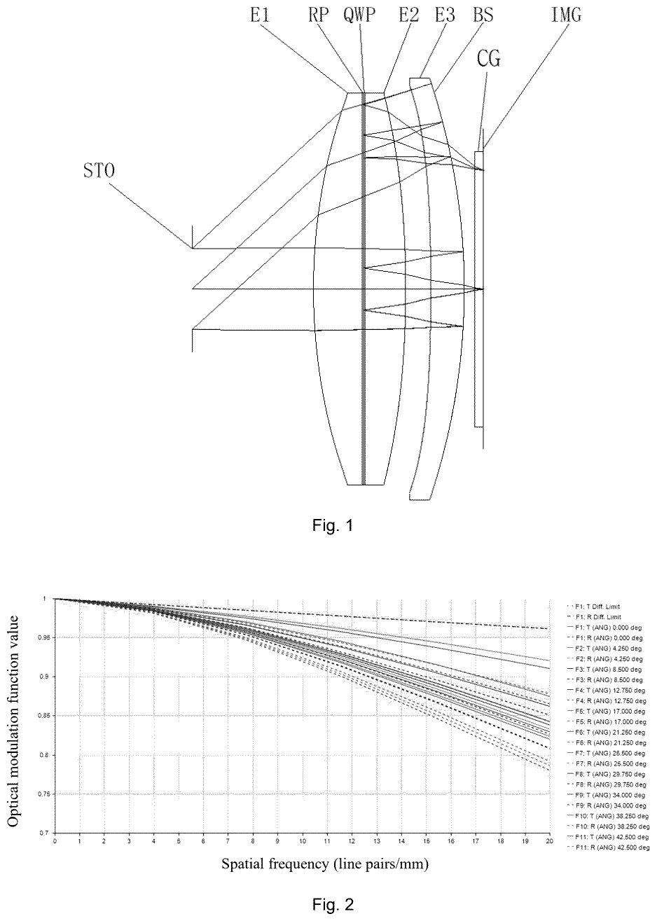

FIG. 2 shows an MTF curve of the visual system according to this embodiment when it is in the +2D state shown in FIG. 1, and FIG. 4 shows an MTF curve of the visual system according to this embodiment when it is in the −5D state shown in FIG. 3. The MTF (Modulation Transfer Function) curves can represent optical modulation function values associated with different spatial frequencies. It can be seen from FIGS. 2 and 4 that the visual system given in this embodiment can achieve good imaging quality in both the +2D and −5D focal length states.

### Embodiment 2

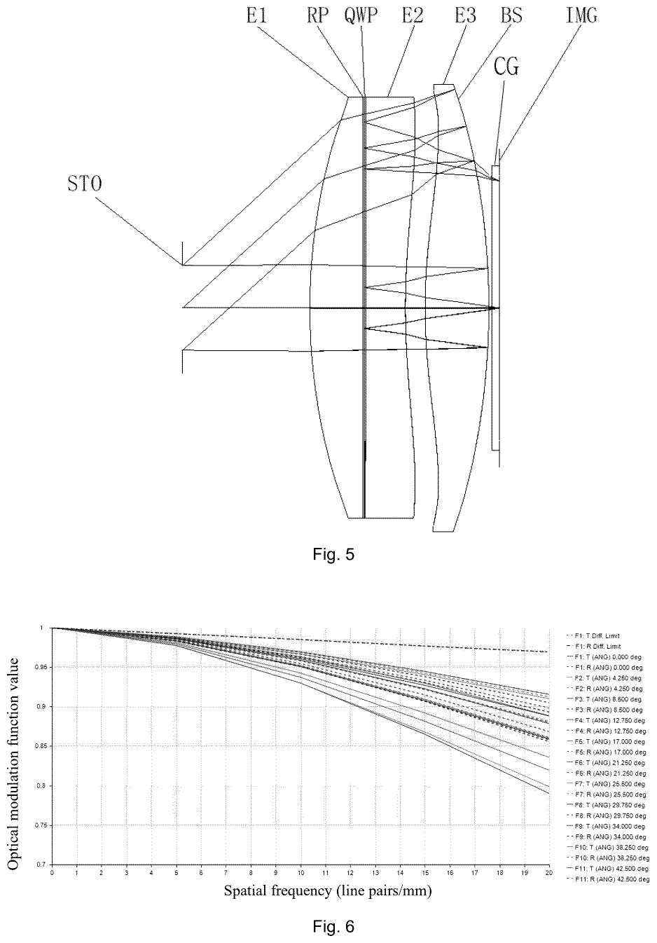

A visual system according to Embodiment 2 of the present application will be described below with reference to FIGS. 5 to 8. In this embodiment and each of the following embodiments, for the sake of brevity, the description of parts similar to those in Embodiment 1 will be omitted.

In this example, the visual system also includes a first lens E1, a reflective polarizing element RP, a quarter-wave plate QWP, a second lens E2, a third lens E3, and a partially reflective element BS arranged in order from a first side to a second side along an optical axis. The first lens E1 has a positive refractive power, with a first side surface being convex and a second side surface being convex; the second lens E2 has a negative refractive power, with a first side surface being concave and a second side surface being concave; the third lens E3 has a positive refractive power, with a first side surface being convex and a second side surface being convex; the reflective polarizing element RP is disposed on the second side surface of the first lens E1, and the quarter-wave plate QWP is disposed on a second side surface of the reflective polarizing element RP. Meanwhile, a second side surface of the quarter-wave plate QWP is attached to a first side surface of the second lens. That is, the first lens E1, the second lens E2, and the reflective polarizing element RP and the quarter-wave plate QWP located therebetween form a cemented lens.

Table 4 shows basic parameters of the visual system according to this embodiment.

TABLE 4

| | | Surface | Radius of | Thickness/ | Refractive | Dispersion | Refraction/ | Cone |
|---|---|---|---|---|---|---|---|---|
| Surface | Element | type | curvature | distance | index | coefficient | reflection | coefficient |
| S0 | | Spherical | Infinite | D1 | | | Refraction | |
| S1 | | Spherical | Infinite | 0.0000 | | | Refraction | |
| S2 | Stop (STO) | Spherical | Infinite | 12.0000 | | | Refraction | |
| S3 | First lens (E1) | Aspherical | 55.8528 | 5.0000 | 1.610 | 60.15 | Refraction | −2.5843 |
| S4 | Reflective polarizing | Spherical | −27174.3059 | 0.1180 | 1.487 | 57.47 | Refraction | |
| | element (RP) | | | | | | | |
| S5 | Quarter-wave plate | Spherical | −27174.3059 | 0.1340 | 1.487 | 57.47 | Refraction | |
| | (QWP) | | | | | | | |
| S6 | Second lens (E2) | Spherical | −27174.3059 | 3.7468 | 1.694 | 29.85 | Refraction | |
| S7 | | Aspherical | 68.2174 | D2 | | | Refraction | −37.6430 |
| S8 | Third lens (E3) | Aspherical | 52.5258 | 6.0085 | 1.655 | 32.56 | Refraction | −16.6652 |
| S9 | Partially reflective | Aspherical | −71.8065 | −6.0085 | 1.655 | 32.56 | Reflection | −0.8325 |
| | element (BS) | | | | | | | |
| S10 | | Aspherical | 52.5258 | D3 | | | Refraction | −16.6652 |
| S11 | | Aspherical | 68.2174 | −3.7468 | 1.694 | 29.85 | Refraction | −37.6430 |
| S12 | | Spherical | −27174.3059 | −0.1340 | 1.487 | 57.47 | Refraction | |
| S13 | Reflective polarizing | Spherical | −27174.3059 | 0.1340 | 1.487 | 57.47 | Reflection | |
| | element (RP) | | | | | | | |
| S14 | Second lens (E2) | Spherical | −27174.3059 | 3.7468 | 1.694 | 29.85 | Refraction | |
| S15 | | Aspherical | 68.2174 | D4 | | | Refraction | −37.6430 |
| S16 | Third lens (E3) | Aspherical | 52.5258 | 6.0085 | 1.655 | 32.56 | Refraction | −16.6652 |
| S17 | | Aspherical | −71.8065 | D5 | | | Refraction | −0.8325 |
| S18 | | Spherical | Infinite | 0.2000 | | | Refraction | |
| S19 | | Spherical | Infinite | 0.7000 | 1.519 | 64.17 | Refraction | |
| S20 | | Spherical | Infinite | 0.0000 | | | Refraction | |
| S21 | Image plane (IMG) | Spherical | Infinite | 0.0000 | | | Refraction | |

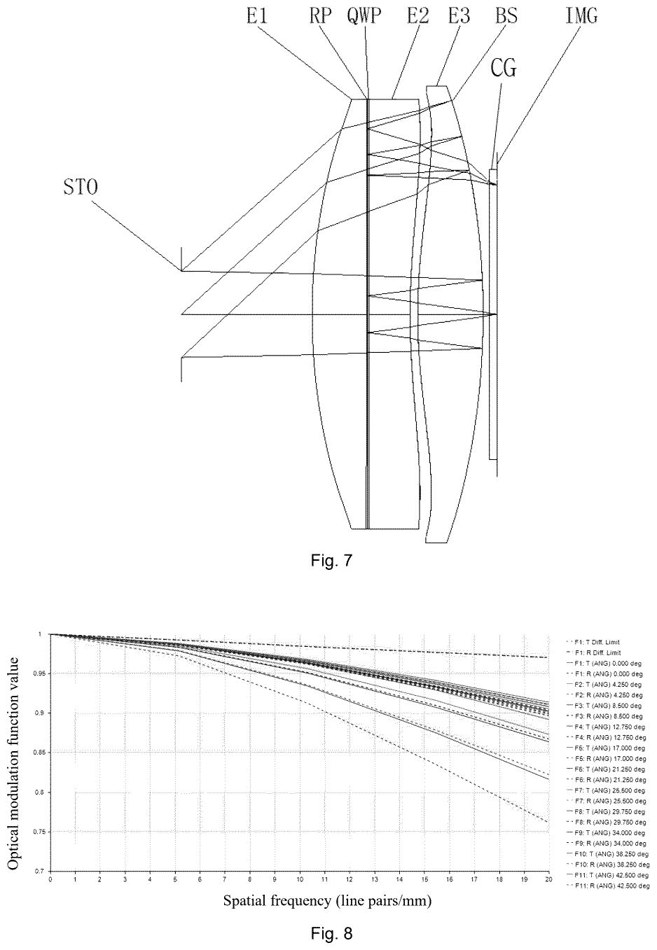

In this example, a stop STO may be provided on the first side of the visual system, an image plane IMG may be provided on the second side of the visual system, and a filter and/or protective glass CG may be provided on the first side of the image plane IMG. The respective distances, along the optical axis, of the first lens E1, the reflective polarizing element RP, the quarter-wave plate QWP, and the second lens E2 to the display/image plane IMG are relatively fixed. The third lens E3 and the partially reflective element BS may be moved along the optical axis to approach or move away from the display/image plane IMG. During this process, the visual system can achieve zooming in the range of −5D to +2D. FIG. 5 shows a schematic structural diagram of the visual system when the third lens E3 and the partially reflective element BS are moved along the optical axis to a position closest to the display/image plane IMG. In this case, the visual system is in a +2D state. FIG. 7 shows a schematic structural diagram of the visual system when the third lens E3 and the partially reflective element BS are moved along the optical axis to a position farthest from the display/image plane IMG. In this case, the visual system is in a −5D state.

The corresponding values of parameters D1 to D5 in Table 4 for the visual system according to this embodiment in the +2D state shown in FIG. 5 and the −5D state shown in FIG. 7 are each shown in Table 5 below. For the meanings of parameters D1 to D5, reference can be made to the description in Embodiment 1.

TABLE 5

| | D1 | D2 | D3 | D4 | D5 |
|---|---|---|---|---|---|
| +2D state | 500.0000 | 1.8633 | −1.8633 | 1.8633 | 0.1000 |
| −5D state | −200.0000 | 0.7000 | −0.7000 | 0.7000 | 0.3778 |

In this embodiment, the first side surface S3 of the first lens E1, the second side surface S7 of the second lens E2, and the first side surface S16 and the second side surface S17 of the third lens E3 are all aspherical surfaces. The surface profile of each aspherical surface can be calculated using formula (1) in Embodiment 1. Higher-order coefficients A₄, A₆, A₈, A₁₀, A₁₂, A₁₄, A₁₆, A₁₈, and A₂₀ that can be used for each of the aspherical lens surfaces S3, S7 and S16-S17 in this embodiment are given in Table 6 below.

TABLE 6

| Co- | | | | |
|---|---|---|---|---|
| effi- | surface | | | |
| cient | S3 | S7 | S16 | S17 |
| A4 | −6.2059E−07 | −6.1402E−06 | −8.6982E−06 | −2.0727E−07 |
| A6 | 1.0575E−08 | −4.5660E−09 | 7.1854E−10 | −1.7448E−09 |
| A8 | −7.7003E−12 | 5.1078E−12 | −1.6743E−11 | −3.0691E−13 |
| A10 | 0.0000E+00 | 0.0000E+00 | 0.0000E+00 | 0.0000E+00 |
| A12 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

FIG. 6 shows an MTF curve of the visual system according to this embodiment when it is in the +2D state shown in FIG. 5, and FIG. 8 shows an MTF curve of the visual system according to this embodiment when it is in the −5D state shown in FIG. 7. It can be seen from FIGS. 6 and 8 that the visual system given in this embodiment can achieve good imaging quality in both the +2D and −5D focal length states.

### Embodiment 3

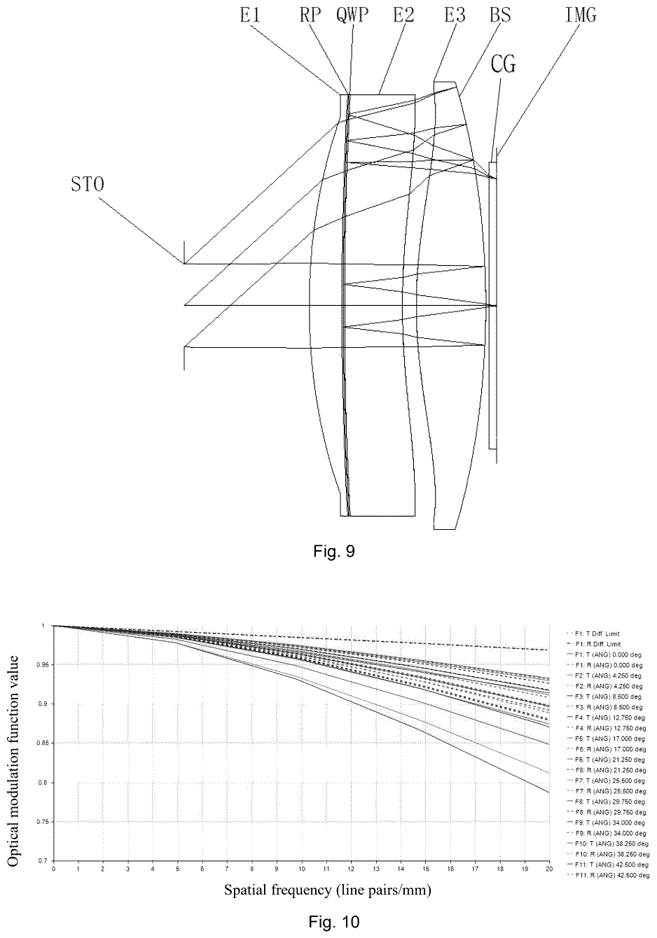

A visual system according to Embodiment 3 of the present application will be described below with reference to FIGS. 9 to 12.

In this example, the visual system also includes a first lens E1, a reflective polarizing element RP, a quarter-wave plate QWP, a second lens E2, a third lens E3, and a partially reflective element BS arranged in order from a first side to a second side along an optical axis. The first lens E1 has a positive refractive power, with a first side surface being convex and a second side surface being concave; the second lens E2 has a negative refractive power, with a first side surface being convex and a second side surface being concave; the third lens E3 has a positive refractive power, with a first side surface being convex and a second side surface being convex; the reflective polarizing element RP is disposed on the second side surface of the first lens E1, and the quarter-wave plate QWP is disposed on a second side surface of the reflective polarizing element RP. Meanwhile, a second side surface of the quarter-wave plate QWP is attached to a first side surface of the second lens. That is, the first lens E1, the second lens E2, and the reflective polarizing element RP and the quarter-wave plate QWP located therebetween form a cemented lens.

Table 7 shows basic parameters of the visual system according to this embodiment.

TABLE 7

| | | | Radius of | Thickness/ | Refractive | Dispersion | Refraction/ | Cone |
|---|---|---|---|---|---|---|---|---|
| Surface | Element | Surface type | curvature | distance | index | coefficient | reflection | coefficient |
| S0 | | Spherical | Infinite | D1 | | | Refraction | |
| S1 | | Spherical | Infinite | 0.0000 | | | Refraction | |
| S2 | Stop (STO) | Spherical | Infinite | 12.0000 | | | Refraction | |
| S3 | First lens (E1) | Aspherical | 59.9945 | 3.1341 | 1.490 | 70.40 | Refraction | 0.2377 |
| S4 | Reflective polarizing | Spherical | 388.5624 | 0.1180 | 1.487 | 57.47 | Refraction | |
| | element (RP) | | | | | | | |
| S5 | Quarter-wave plate | Spherical | 388.5624 | 0.1340 | 1.487 | 57.47 | Refraction | |
| | (QWP) | | | | | | | |
| S6 | Second lens (E2) | Spherical | 388.5624 | 5.5416 | 1.764 | 27.58 | Refraction | |
| S7 | | Aspherical | 67.6325 | D2 | | | Refraction | −28.3345 |
| S8 | Third lens (E3) | Aspherical | 46.2216 | 6.6597 | 1.666 | 32.87 | Refraction | −11.9528 |
| S9 | Partially reflective | Aspherical | −84.6748 | −6.6597 | 1.666 | 32.87 | Reflection | −1.1535 |
| | element (BS) | | | | | | | |
| S10 | | Aspherical | 46.2216 | D3 | | | Refraction | −11.9528 |
| S11 | | Aspherical | 67.6325 | −5.5416 | 1.764 | 27.58 | Refraction | −28.3345 |
| S12 | | Spherical | 388.5624 | −0.1340 | 1.487 | 57.47 | Refraction | |
| S13 | Reflective polarizing | Spherical | 388.5624 | 0.1340 | 1.487 | 57.47 | Reflection | |
| | element (RP) | | | | | | | |
| S14 | Second lens (E2) | Spherical | 388.5624 | 5.5416 | 1.764 | 27.58 | Refraction | |
| S15 | | Aspherical | 67.6325 | D4 | | | Refraction | −28.3345 |
| S16 | Third lens (E3) | Aspherical | 46.2216 | 6.6597 | 1.666 | 32.87 | Refraction | −11.9528 |
| S17 | | Aspherical | −84.6748 | D5 | | | Refraction | −1.1535 |
| S18 | | Spherical | Infinite | 0.2000 | | | Refraction | |
| S19 | | Spherical | Infinite | 0.7000 | 1.519 | 64.17 | Refraction | |
| S20 | | Spherical | Infinite | 0.0000 | | | Refraction | |
| S21 | Image plane (IMG) | Spherical | Infinite | 0.0000 | | | Refraction | |

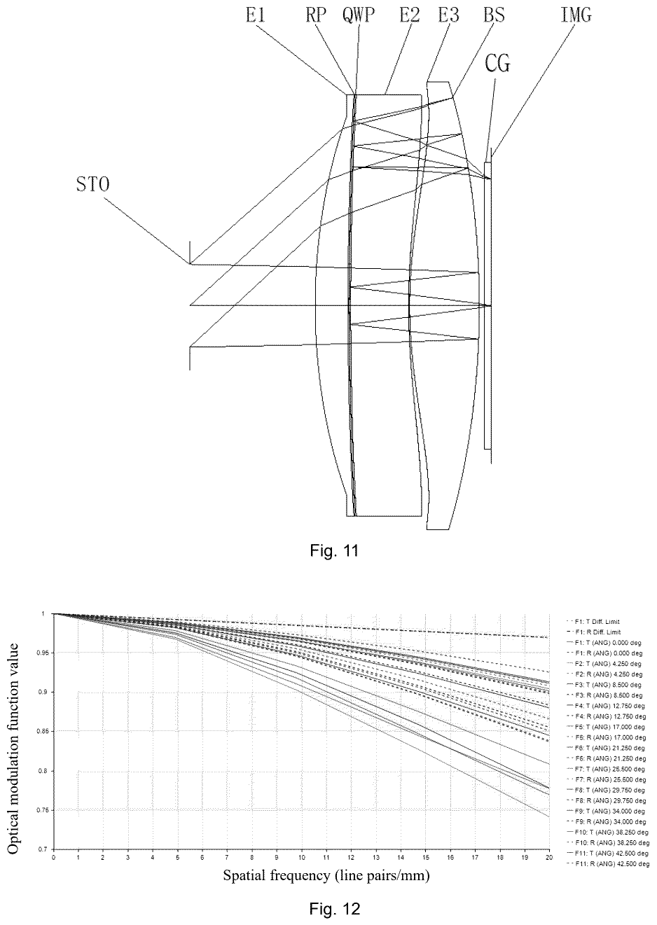

In this example, a stop STO may be provided on the first side of the visual system, an image plane IMG may be provided on the second side of the visual system, and a filter and/or protective glass CG may be provided on the first side of the image plane IMG. The respective distances, along the optical axis, of the first lens E1, the reflective polarizing element RP, the quarter-wave plate QWP, and the second lens E2 to the display/image plane IMG are relatively fixed. The third lens E3 and the partially reflective element BS may be moved along the optical axis to approach or move away from the display/image plane IMG. During this process, the visual system can achieve zooming in the range of −5D to +2D. FIG. 9 shows a schematic structural diagram of the visual system when the third lens E3 and the partially reflective element BS are moved along the optical axis to a position closest to the display/image plane IMG. In this case, the visual system is in a +2D state. FIG. 11 shows a schematic structural diagram of the visual system when the third lens E3 and the partially reflective element BS are moved along the optical axis to a position farthest from the display/image plane IMG. In this case, the visual system is in a −5D state.

The corresponding values of parameters D1 to D5 in Table 7 for the visual system according to this embodiment in the +2D state shown in FIG. 9 and the −5D state shown in FIG. 11 are each shown in Table 8 below. For the meanings of parameters D1 to D5, reference can be made to the description in Embodiment 1.

TABLE 8

| | D1 | D2 | D3 | D4 | D5 |
|---|---|---|---|---|---|
| +2D state | 500.0000 | 1.3378 | −1.3378 | 1.3378 | 0.1276 |
| −5D state | −200.0000 | 0.1000 | −0.1000 | 0.1000 | 0.2632 |

In this embodiment, the first side surface S3 of the first lens E1, the second side surface S7 of the second lens E2, and the first side surface S16 and the second side surface S17 of the third lens E3 are all aspherical surfaces. The surface profile of each aspherical surface can be calculated using formula (1) in Embodiment 1. Higher-order coefficients A₄, A₆, A₈, A₁₀, A₁₂, A₁₄, A₁₆, A₁₈, and A₂₀ that can be used for each of the aspherical lens surfaces S3, S7 and S16-S17 in this embodiment are given in Table 9 below.

TABLE 9

| Co- | | | | |
|---|---|---|---|---|
| effi- | surface | | | |
| cient | S3 | S7 | S16 | S17 |
| A4 | 1.3824E−06 | −4.5944E−06 | −7.1887E−06 | −1.6732E−07 |
| A6 | −1.2784E−09 | −1.9725E−09 | 1.5743E−09 | −1.2878E−09 |
| A8 | 2.4030E−12 | 2.6015E−13 | −1.2408E−11 | −2.8083E−13 |
| A10 | 0.0000E+00 | 0.0000E+00 | 0.0000E+00 | 0.0000E+00 |
| A12 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

FIG. 10 shows an MTF curve of the visual system according to this embodiment when it is in the +2D state shown in FIG. 9, and FIG. 12 shows an MTF curve of the visual system according to this embodiment when it is in the −5D state shown in FIG. 11. It can be seen from FIGS. 10 and 12 that the visual system given in this embodiment can achieve good imaging quality in both the +2D and −5D focal length states.

### Embodiment 4

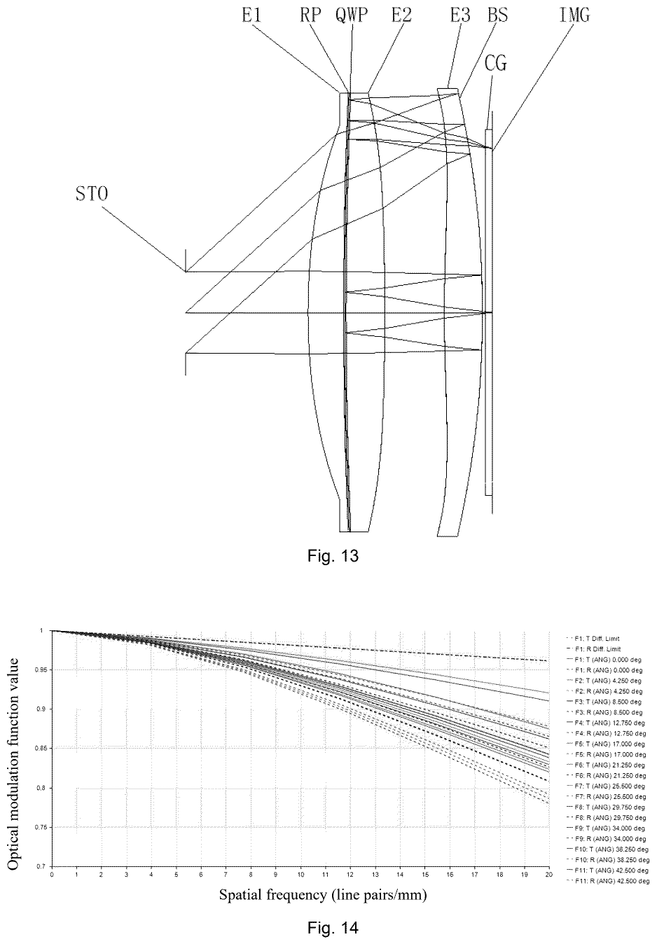

A visual system according to Embodiment 4 of the present application will be described below with reference to FIGS. 13 to 16.

In this example, the visual system also includes a first lens E1, a reflective polarizing element RP, a quarter-wave plate QWP, a second lens E2, a third lens E3, and a partially reflective element BS arranged in order from a first side to a second side along an optical axis. The first lens E1 has a positive refractive power, with a first side surface being convex and a second side surface being concave; the second lens E2 has a positive refractive power, with a first side surface being convex and a second side surface being convex; the third lens E3 has a positive refractive power, with a first side surface being convex and a second side surface being convex; the reflective polarizing element RP is disposed on the second side surface of the first lens E1, and the quarter-wave plate QWP is disposed on a second side surface of the reflective polarizing element RP. Meanwhile, a second side surface of the quarter-wave plate QWP is attached to a first side surface of the second lens. That is, the first lens E1, the second lens E2, and the reflective polarizing element RP and the quarter-wave plate QWP located therebetween form a cemented lens.

Table 10 shows basic parameters of the visual system according to this embodiment.

TABLE 10

| | | | Radius of | Thickness/ | Refractive | Dispersion | Refraction/ | Cone |
|---|---|---|---|---|---|---|---|---|
| Surface | Element | Surface type | curvature | distance | index | coefficient | reflection | coefficient |
| S0 | | Spherical | Infinite | D1 | | | Refraction | |
| S1 | | Spherical | Infinite | 0.0000 | | | Refraction | |
| S2 | Stop (STO) | Spherical | Infinite | 12.0000 | | | Refraction | |
| S3 | First lens (E1) | Aspherical | 64.5487 | 3.5000 | 1.490 | 70.40 | Refraction | 1.3701 |
| S4 | Reflective polarizing | Spherical | 527.9075 | 0.1180 | 1.487 | 57.47 | Refraction | |
| | element (RP) | | | | | | | |
| S5 | Quarter-wave plate | Spherical | 527.9075 | 0.1340 | 1.487 | 57.47 | Refraction | |
| | (QWP) | | | | | | | |
| S6 | Second lens (E2) | Spherical | 527.9075 | 3.7765 | 1.490 | 70.40 | Refraction | |
| S7 | | Aspherical | −500.0000 | D2 | | | Refraction | 4.3746 |
| S8 | Third lens (E3) | Aspherical | 151.7201 | 3.7477 | 1.490 | 70.40 | Refraction | −5.6027 |
| S9 | Partially reflective | Aspherical | −105.3251 | −3.7477 | 1.490 | 70.40 | Reflection | 1.5612 |
| | element (BS) | | | | | | | |
| S10 | | Aspherical | 151.7201 | D3 | | | Refraction | −5.6027 |
| S11 | | Aspherical | −500.0000 | −3.7765 | 1.490 | 70.40 | Refraction | 4.3746 |
| S12 | | Spherical | 527.9075 | −0.1340 | 1.487 | 57.47 | Refraction | |
| S13 | Reflective polarizing | Spherical | 527.9075 | 0.1340 | 1.487 | 57.47 | Reflection | |
| | element (RP) | | | | | | | |
| S14 | Second lens (E2) | Spherical | 527.9075 | 3.7765 | 1.490 | 70.40 | Refraction | |
| S15 | | Aspherical | −500.0000 | D4 | | | Refraction | 4.3746 |
| S16 | Third lens (E3) | Aspherical | 151.7201 | 3.7477 | 1.490 | 70.40 | Refraction | −5.6027 |
| S17 | | Aspherical | −105.3251 | D5 | | | Refraction | 1.5612 |
| S18 | | Spherical | Infinite | 0.2000 | | | Refraction | |
| S19 | | Spherical | Infinite | 0.7000 | 1.519 | 64.17 | Refraction | |
| S20 | | Spherical | Infinite | 0.0000 | | | Refraction | |
| S21 | Image plane (IMG) | Spherical | Infinite | 0.0000 | | | Refraction | |

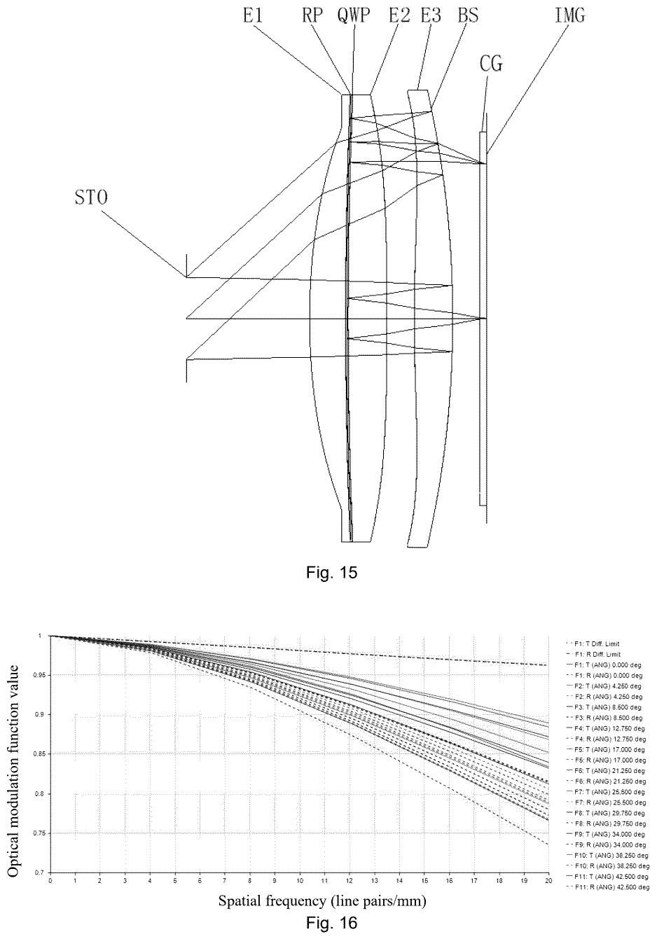

In this example, a stop STO may be provided on the first side of the visual system, an image plane IMG may be provided on the second side of the visual system, and a filter and/or protective glass CG may be provided on the first side of the image plane IMG. The respective distances, along the optical axis, of the first lens E1, the reflective polarizing element RP, the quarter-wave plate QWP, and the second lens E2 to the display/image plane IMG are relatively fixed. The third lens E3 and the partially reflective element BS may be moved along the optical axis to approach or move away from the display/image plane IMG. During this process, the visual system can achieve zooming in the range of −5D to +2D. FIG. 13 shows a schematic structural diagram of the visual system when the third lens E3 and the partially reflective element BS are moved along the optical axis to a position closest to the display/image plane IMG. In this case, the visual system is in a +2D state. FIG. 15 shows a schematic structural diagram of the visual system when the third lens E3 and the partially reflective element BS are moved along the optical axis to a position farthest from the display/image plane IMG. In this case, the visual system is in a −5D state.

The corresponding values of parameters D1 to D5 in Table 10 for the visual system according to this embodiment in the +2D state shown in FIG. 13 and the −5D state shown in FIG. 15 are each shown in Table 11 below. For the meanings of parameters D1 to D5, reference can be made to the description in Embodiment 1.

TABLE 11

| | D1 | D2 | D3 | D4 | D5 |
|---|---|---|---|---|---|
| +2D state | 500.0000 | 5.8715 | −5.8715 | 5.8715 | 0.1000 |
| −5D state | −200.0000 | 2.6460 | −2.6460 | 2.6460 | 2.4206 |

In this embodiment, the first side surface S3 of the first lens E1, the second side surface S7 of the second lens E2, and the first side surface S16 and the second side surface S17 of the third lens E3 are all aspherical surfaces. The surface profile of each aspherical surface can be calculated using formula (1) in Embodiment 1. Higher-order coefficients A₄, A₆, A₈, A₁₀, A₁₂, A₁₄, A₁₆, A₁₈, and A₂₀ that can be used for each of the aspherical lens surfaces S3, S7 and S16-S17 in this embodiment are given in Table 12 below.

TABLE 12

| Co- | | | | |
|---|---|---|---|---|
| effi- | surface | | | |
| cient | S3 | S7 | S16 | S17 |
| A4 | 3.1529E−06 | −4.7305E−06 | −9.8957E−06 | −7.1448E−07 |
| A6 | −3.5374E−09 | −4.3884E−09 | 1.3914E−09 | 1.6825E−10 |
| A8 | 6.1799E−12 | 7.7723E−12 | −8.7757E−13 | 1.9656E−12 |
| A10 | 0.0000E+00 | 0.0000E+00 | 0.0000E+00 | 0.0000E+00 |
| A12 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

FIG. 14 shows an MTF curve of the visual system according to this embodiment when it is in the +2D state shown in FIG. 13, and FIG. 16 shows an MTF curve of the visual system according to this embodiment when it is in the −5D state shown in FIG. 15. It can be seen from FIGS. 14 and 16 that the visual system given in this embodiment can achieve good imaging quality in both the +2D and −5D focal length states.

In summary, in Embodiments 1 to 4, the effective focal length fm of the visual system in the +2D state, the effective focal length fn of the visual system in the −5D state, the effective focal length f1 of the first lens, the effective focal length f2 of the second lens, the effective focal length f3 of the third lens, the combined focal length fz of the first lens, the reflective polarizing element, the quarter-wave plate, and the second lens, the entrance pupil diameter EPD of the visual system, the distance TDm on the optical axis from the first side surface of the first lens to the second side surface of the third lens in the +2D state of the visual system, the distance TDn on the optical axis from the first side surface of the first lens to the second side surface of the third lens in the −5D state of the visual system, the distance T23m on the optical axis from the second side surface of the second lens to the first side surface of the third lens in the +2D state of the visual system, the distance T23n on the optical axis from the second side surface of the second lens to the first side surface of the third lens in the −5D state of the visual system, the distance BFLm on the optical axis from the second side surface of the third lens to the display/image plane in the +2D state of the visual system, and the distance BFLn on the optical axis from the second side surface of the third lens to the display/image plane in the −5D state of the visual system, the distance ΔL by which the third lens moves along the optical axis when the visual system switches from the +2D state to the −5D state, and the amount of change Δf in the effective focal length of the system when the visual system switches from the +2D state to the −5D state are each shown in Table 13 below.

TABLE 13

| | Embodiment | | | |
|---|---|---|---|---|
| | Embodi- | Embodi- | Embodi- | Embodi- |
| Parameter | ment 1 | ment 2 | ment 3 | ment 4 |
| fm (mm) | 17.29 | 17.74 | 18.16 | 23.39 |
| fn (mm) | 16.19 | 17.26 | 17.54 | 21.32 |
| f1 (mm) | 104.06 | 91.38 | 144.40 | 149.78 |
| f2 (mm) | 197.26 | −98.02 | −107.95 | 524.92 |
| f3 (mm) | 162.38 | 47.24 | 45.83 | 127.54 |
| fz (mm) | 69.48 | 739.16 | −521.09 | 117.23 |
| EPD (mm) | 8.00 | 8.00 | 8.00 | 8.00 |
| TDm (mm) | 14.93 | 16.87 | 16.93 | 17.15 |
| TDn (mm) | 12.94 | 15.71 | 15.69 | 13.92 |
| T23m (mm) | 2.50 | 1.86 | 1.34 | 5.87 |
| T23n (mm) | 0.50 | 0.70 | 0.10 | 2.65 |
| BFLm (mm) | 1.90 | 1.00 | 1.03 | 1.00 |
| BFLn (mm) | 3.90 | 1.28 | 1.16 | 3.32 |
| ΔL (mm) | 2.00 | 1.16 | 1.24 | 3.23 |
| Δf (mm) | 1.10 | 0.48 | 0.62 | 2.07 |

In addition, Embodiments 1 to 4 satisfy the conditions shown in Table 14, respectively.

TABLE 14

| | Embodiment | | | |
|---|---|---|---|---|
| | Embodi- | Embodi- | Embodi- | Embodi- |
| Conditional Expression | ment 1 | ment 2 | ment 3 | ment 4 |
| f3/\|fz\| | 2.34 | 0.06 | 0.09 | 1.09 |
| f3/(fm + fn) | 4.85 | 1.35 | 1.28 | 2.85 |
| ΔL/CT3 | 0.60 | 0.19 | 0.19 | 0.86 |
| (CT1 + CT2)/Δf | 8.06 | 18.12 | 14.07 | 3.51 |
| fm/(T23m + T23n) | 5.77 | 6.92 | 12.63 | 2.75 |
| \|R5/R4\| × ΔL (mm) | 4.08 | 0.90 | 0.85 | 0.98 |
| R1/(TDm + TDn) | 2.06 | 1.71 | 1.84 | 2.08 |
| \|f1/f2\| × Δf (mm) | 0.58 | 0.45 | 0.82 | 0.59 |
| f3/TDm | 10.87 | 2.80 | 2.71 | 7.44 |
| CT3/(BFLm + BFLn) | 0.57 | 2.64 | 3.04 | 0.87 |
| R6/TDn | −4.96 | −4.57 | −5.40 | −7.57 |
| (fm + fn)/EPD | 4.18 | 4.37 | 4.46 | 5.59 |
| (CT2 + CTR + CTQ)/ | 1.72 | 2.15 | 4.33 | 0.69 |
| T23m | | | | |
| BFLn/N3 (mm) | 2.51 | 0.77 | 0.70 | 2.23 |
| R1/fn | 3.54 | 3.24 | 3.42 | 3.03 |
| TDm/CT1 | 3.09 | 3.37 | 5.40 | 4.90 |
| (f1/V1)/ΔL | 0.93 | 1.31 | 1.66 | 0.66 |

The above description is only the preferred embodiments of the present application and the explanation of the applied technical principle. It should be understood by those skilled in the art that the scope of protection involved in the present application is not limited to technical solutions formed by specific combinations of the above technical features, and at the same time, should also cover other technical solutions formed by any combination of the above technical features or equivalent features thereof without departing from the concept of the present application. For example, the above features are replaced with (but not limited to) the technical features with similar functions disclosed in the present application to form technical solutions.

What is claimed is:

1. A visual system, comprising, in order from a first side to a second side along an optical axis:
a first lens having a positive refractive power, with a first side surface being convex;
a reflective polarizing element;
a quarter-wave plate;
a second lens having a positive refractive power or a negative refractive power;
a third lens having a positive refractive, with a second side surface being convex; and
a partially reflective element,
wherein the third lens is configured to be able to move along the optical axis to approach or move away from a display located on the second side, so that the visual system switches between a first state and a second state; and
the visual system satisfies:
$$0.05 < f 3 / fz < 2.35 ;$$
$$1.28 \leq f 3 / ( fm + fn ) \leq 4.85 ; and$$
$$0.19 \leq Δ L / CT 3 \leq 0 \text{.86} ;$$
where f3 is an effective focal length of the third lens, fz is a combined focal length of the first lens, the reflective polarizing element, the quarter-wave plate, and the second lens, fm is an effective focal length of the visual system in the first state, fn is the effective focal length of the visual system in the second state, ΔL is a distance by which the third lens moves along the optical axis in a process of the visual system switching from the first state to the second state, and CT3 is a center thickness of the third lens on the optical axis.

2. The visual system according to claim 1, wherein a center thickness CT1 of the first lens on the optical axis, a center thickness CT2 of the second lens on the optical axis, and an amount of change Δf in the effective focal length of the visual system when switching from the first state to the second state satisfy:
$$3.51 \leq ( CT 1 + CT 2 ) / Δ f \leq 18.12 .$$

3. The visual system according to claim 1, wherein the effective focal length fm of the visual system in the first state, and a distance T23m on the optical axis from a second side surface of the second lens to a first side surface of the third lens in the first state of the visual system and a distance T23n on the optical axis from the second side surface of the second lens to the first side surface of the third lens in the second state of the visual system satisfy:
$$2.75 \leq fm / ( T 23 m + T 23 n ) \leq 12.6 3 .$$

4. The visual system according to claim 1, wherein a radius of curvature R5 of a first side surface of the third lens and a radius of curvature R4 of a second side surface of the second lens, and the distance ΔL by which the third lens moves along the optical axis in a process of the visual system switching from the first state to the second state satisfy:
0.85 mm≤|R5/R4|×ΔL≤4.08 mm.

5. The visual system according to claim 1, wherein a radius of curvature R1 of the first side surface of the first lens, a distance TDm on the optical axis from the first side surface of the first lens to the second side surface of the third lens in the first state of the visual system, and a distance TDn on the optical axis from the first side surface of the first lens to the second side surface of the third lens in the second state of the visual system satisfy:
$$1.7 < R 1 / ( TDm + TDn ) < 2.1 .$$

6. The visual system according to claim 1, wherein an effective focal length f1 of the first lens, an effective focal length f2 of the second lens, and an amount of change Δf in the effective focal length of the visual system when switching from the first state to the second state satisfy:
$$0.45 mm \leq \vert f 1 / f 2 \vert \times Δ f \leq 0.82 mm .$$

7. The visual system according to claim 1, wherein the effective focal length f3 of the third lens, and a distance TDm on the optical axis from the first side surface of the first lens to the second side surface of the third lens in the first state of the visual system satisfy:
$$2.7 < f 3 / TDm < 10.9 .$$

8. The visual system according to claim 1, wherein the center thickness CT3 of the third lens on the optical axis, and a distance BFLm on the optical axis from the second side surface of the third lens to the display in the first state of the visual system, and a distance BFLn on the optical axis from the second side surface of the third lens to the display in the second state of the visual system satisfy:
$$0.55 < CT 3 / ( BFLm + BFLn ) < 3.05 .$$

9. The visual system according to claim 1, wherein a radius of curvature R6 of the second side surface of the third lens and a distance TDn on the optical axis from the first side surface of the first lens to the second side surface of the third lens in the second state of the visual system satisfy:
$$- 7.57 \leq R 6 / TDn \leq - 4.57 .$$

10. The visual system according to claim 1, wherein the effective focal length fm of the visual system in the first state, the effective focal length fn of the visual system in the second state, and an entrance pupil diameter EPD of the visual system satisfy:
4.15<(fm+fn)/EPD<5.6.

11. The visual system according to claim 1, wherein a center thickness CT2 of the second lens on the optical axis, a center thickness CTR of the reflective polarizing element on the optical axis, a center thickness CTQ of the quarter-wave plate on the optical axis, and a distance T23m on the optical axis from a second side surface of the second lens to a first side surface of the third lens in the first state of the visual system satisfy:
$$0.65 < ( CT 2 + CTR + CTQ ) / T 23 m < 4.35 .$$

12. The visual system according to claim 1, wherein a distance BFLn on the optical axis from the second side surface of the third lens to the display in the second state of the visual system, and a refractive index N3 of the third lens satisfy:
$$0.7 mm \leq BFLn / N 3 \leq 2.51 mm .$$

13. The visual system according to claim 1, wherein a radius of curvature R1 of the first side surface of the first lens and the effective focal length fn of the visual system in the second state satisfy:
$$3. < R 1 / fn < 3.55 .$$

14. The visual system according to claim 1, wherein a distance TDm on the optical axis from the first side surface of the first lens to the second side surface of the third lens in the first state of the visual system, and a center thickness CT1 of the first lens on the optical axis satisfy:
$$3.09 \leq TDm / CT 1 \leq 5.40 .$$

15. The visual system according to claim 1, wherein an effective focal length f1 of the first lens and a dispersion coefficient V1 of the first lens, and the distance ΔL by which the third lens moves along the optical axis in a process of the visual system switching from the first state to the second state satisfy:
$$0.66 \leq ( f 1 / V 1 ) / Δ L \leq 1.66 .$$
